(19) United States
(12) Patent Application Publication
(10) Pub. No.: US 2022/0287498 A1
(43) Pub. Date: Sep. 15, 2022

(54) METHOD AND DEVICE FOR AUTOMATICALLY COOKING FOOD

(71) Applicant: SHANGHAI CHANGSHAN INTELLIGENT TECHNOLOGY CORPORATION LIMITED, Shanghai (CN)

(72) Inventor: Xinlei HUA, Shanghai (CN)

(21) Appl. No.: 17/602,744

(22) PCT Filed: Mar. 31, 2020
(86) PCT No.: PCT/CN2020/082370

§ 371 Date: May 16, 2022

(30) Foreign Application Priority Data
Apr. 11, 2019 (CN) 201910288739.X

(51) Int. Cl. A47J 36/32; A23L 5/10; G06V 20/68; G06V 10/82; G06V 10/774

(52) U.S. Cl. CPC A47J 36/32; A23L 5/10; G06V 20/68; G06V 10/82; G06V 10/774; A47J 2202/00; A23V 2002/00

(57) ABSTRACT

The present application relates to a method for automatically cooking food, and the method comprises acquiring an initial image of at least one food ingredient, the initial image being acquired before cooking or when the cooking is not complete; processing the initial image to extract characteristic parameters of at least one food ingredient, wherein the characteristic parameters of the food ingredient indicates the cooking characteristics of the food ingredient; determining cooking condition parameters for at least one food ingredient based on characteristic parameters of at least one food ingredient.

### TECHNICAL FIELD

This application relates to automatic food cooking, and more specifically, to a method and a device for automatic food cooking.

### BACKGROUND

With the acceleration of the pace of life in modern society and the continuous improvement of the intelligence of home appliances, various automatic cooking devices also emerged. The current automatic cooking devices on the market often need to perform standard cooking procedures. Even if some equipment provides personalized options, the adjustable parameters are relatively simple. However, the difference in the state of the ingredients such as the types of food ingredients, parts (such as vegetable leaves and roots), batches (such as the fat to lean of pork belly), harvest seasons, and freshness (such as fresh or dry), starting temperatures (such as winter or summer, just out of the refrigerator or at room temperature), and the shape and size of the ingredients may lead to significant differences in the taste and quality of the final dishes during the cooking process, Based on the above factors, even if the same automatic cooking equipment is used to perform the same cooking procedure on the same ingredients, it is possible to obtain finished dishes with quite different taste and quality.

In addition, the current automatic cooking device obviously cannot fully consider the various states and parameter changes of the ingredients during the cooking process, such as the speed of doneness, whether to be overheated, the uniformity, and the humidity. Therefore, the current automatic cooking equipment is prone to various degrees of deviation during the cooking process and cannot guarantee the consistency of the quality and flavor of the dishes.

### SUMMARY

The present application provides a method and a device for automatically cooking food, which determines and adjusts corresponding cooking parameters based on the state of food ingredients in real-time, thereby cooking dishes with stable quality.

In one aspect of the present application, a method for automatically cooking food is provided, the method comprising: acquiring an initial image of at least one food ingredient, the initial image being acquired before cooking or when the cooking is not complete; processing the initial image to extract characteristic parameters of at least one food ingredient, wherein the characteristic parameters of the food ingredient indicates the cooking characteristics of the food ingredient; determining cooking condition parameters for at least one food ingredient based on characteristic parameters of at least one food ingredient;

In some embodiments, the characteristic parameters comprise at least one food ingredient of name, type, bulk density, weight, color, texture, shape, size, freshness, humidity, color, doneness, surface burnt, color changes of different parts and relationship between a plurality of processing objects.

In some embodiments, the cooking condition parameters comprise at least one of heating temperature, heating power, heating time, whether to add water, the amount of water added, the type and amount of seasonings added, stir-frying time, stir-frying speed, stir-frying frequency, extent of the stir-frying, whether to cover the pot, duration of the lid coverage, whether to blow, the force of blow, and duration of the blow.

In some embodiments, at least one food ingredient is in a cooking container for cooking, the initial image of the food ingredient is acquired in the cooking container.

In some embodiments, the method further includes acquiring an intermediate image of at least one food ingredient in the cooking container after a predetermined time interval following the acquisition of the initial image; processing the intermediate image to extract characteristic parameters of at least one food ingredient; wherein the determination of the cooking condition parameters of at least one food ingredient based on the characteristic parameters of at least one food ingredient includes: determining doneness of at least one food ingredient based on the characteristic parameters of at least food ingredient extracted from the initial image and the characteristic parameters and the predetermined time interval extracted from the intermediate image; determining the cooking condition parameters of at least one food ingredient based on the doneness of at least one food ingredient.

In some embodiments, the determination of the cooking condition parameters for at least one food ingredient based on the characteristic parameters of at least one food ingredient comprises comparing the characteristic parameters of at least one food ingredient with a first specified threshold; determining the cooking condition parameters of at least one food ingredient when the characteristic parameters of at least one food ingredient are greater than the first specified threshold.

In some embodiments, the method further includes: acquiring an intermediate image of at least one food ingredient and the intermediate image is acquired after the predetermined time interval following the acquisition of the initial image; processing the intermediate image to extract the characteristic parameters of at least one food ingredient; wherein determining the cooking condition parameter of at least one food ingredient based on the characteristic parameters of at least one food ingredient; comparing the characteristic parameters of at least one food ingredient extracted from the intermediate image with a second specified threshold; determining the cooking condition parameter for at least one food ingredient when the characteristic parameters of at least one food ingredient extracted from the intermediate image are greater than the second specified threshold value.

In some embodiments, the initial image of at least one food ingredient comprises a plurality of processed objects, the method further includes: processing the initial image to extract characteristic parameters of the plurality of processing objects respectively; wherein the determination of the cooking condition parameters of at least one food ingredient based on the characteristic parameters of at least one food ingredient comprises: determining the cooking uniformity of at least one food ingredient based on the numerical distribution of characteristic parameters of the plurality of processing objects; determining the cooking condition parameters for at least one food ingredient based on the cooking uniformity of at least one food ingredient.

In some embodiments, the determination of the cooking condition parameters for at least one food ingredient based on the cooking uniformity of at least one food ingredient comprises determining at least one of the stir-frying time, the stir-frying speed, the stir-frying frequency, and the extent of stir-frying for at least one food ingredients based on the cooking uniformity of at least one food ingredient.

In some embodiments, at least one food ingredient is a food ingredient to be processed in the cooking container.

In some embodiments, the characteristic parameter includes filling condition of at least one food ingredient in the cooking container.

In some embodiments, the determination of the cooking condition parameters of at least one food ingredient based on the characteristic parameters of at least one food ingredient includes: determining weight of at least one food ingredient based on the filling condition of at least one food ingredient in the cooking container. determining the cooking condition parameters of at least one food ingredient based on the weight of at least one food ingredient.

In some embodiments, the processing initial image to extract characteristic parameters of at least one food ingredient or determining the cooking condition parameters of at least one food ingredient based on the characteristic parameters of at least one food ingredient are implemented by deep learning neural network.

In some embodiments, the deep learning neural network uses supervised learning to obtain one or more characteristic parameters of at least one food ingredient or to obtain one or more cooking condition parameters for at least one food ingredient by labeling one or more training samples.

In some embodiments, the deep learning neural network is trained using images acquired at multiple moments during multiple qualified cooking of at least one food ingredient as samples.

In some embodiments, the deep learning neural network is trained with the results of multiple weighing of at least one food ingredient as the actual weights of the ingredients.

In some embodiments, the architecture included in the deep learning neural network is at least one of object detection technology, RetinaNet, Faster R-CNN, and Mask R-CNN.

In some embodiments, the algorithm used by the deep learning neural network includes ResNet, Inception-ResNet, Feature Pyramid Network, Fully Convolutional Network, or Focal Loss.

In some embodiments, the underlying tools of the deep learning neural network include at least one of TensorFlow, Caffe, Torch & Overfeat, MxNet, or Theano.

In another aspect of the present application, an automatic cooking device for automatically cooking food is provided, the device comprises an image sensor a processor configured to perform the following steps: acquiring an initial image of at least one food ingredient, the initial image being acquired before cooking or when the cooking is not complete; processing the initial image to extract characteristic parameters of at least one food ingredient, wherein the characteristic parameters of the food ingredient indicates the cooking characteristics of the food ingredient; determining cooking condition parameters for at least one food ingredient based on characteristic parameters of at least one food ingredient;

In some embodiments, the characteristic parameters comprise at least one food ingredient of name, type, bulk density, weight, color, texture, shape, size, freshness, humidity, color, doneness, surface burnt, color changes of different parts, and relationship between a plurality of processing objects.

In some embodiments, the cooking condition parameters comprise at least one of heating temperature, heating power, heating time, whether to add water, the amount of water added, the type and amount of seasonings added, and stir-frying time, stir-frying speed, stir-frying frequency, extent of the stir-frying, whether to cover the pot, duration of the lid coverage, whether to blow, the force of blow and the duration of the blow.

In some embodiments, the device further includes a cooking container for holding at least one food ingredient for cooking.

In some embodiments, the cooking container has an opening, and during the cooking process, the direction of the opening forms an angle of 0° to 90° with the vertical direction during cooking.

In some embodiments, the image sensor is generally arranged toward the opening of the cooking container and can move relative to the cooking container.

In some embodiments, a transparent part is disposed on the pot body of the cooking container, so that the image sensor acquires an image of at least one of food ingredient in the cooking container with the transparent part.

In some embodiments, the device further includes a cooking mechanism configured to perform the cooking operation on at least one food ingredient in the cooking container based on the cooking condition parameters.

In some embodiments, the cooking mechanism includes a heating device, a stirring device, a stir-frying device, a timing device, a temperature control device, a power adjustment device, a water injection device, an oil injection device, a seasoning device, a starching device, or a dishing device.

In some embodiments, the device includes a temperature sensor for measuring the temperature of the pot body of the cooking container.

In some embodiments, the temperature sensor is an infrared temperature sensor or an array thereof.

In some embodiments, the device further includes a lighting device configured to illuminate at least one food ingredient in the cooking container.

In some embodiments, the device further includes an oil fume extractor, which is used to suck oil fume in the cooking container.

The above is an overview of the application, and may be simplified, summarized and omitted in detail. Therefore, those skilled in the art should recognize that this part is only illustrative and is not intended to limit the scope of the application in any way. This summary is neither intended to determine the key features or essential features of the claimed subject matter, nor is it intended to be used as an auxiliary means to determine the scope of the claimed subject matter.

### BRIEF DESCRIPTION OF THE DRAWINGS

The above and other features of the content of this application will be more fully understood through the following description and appended claims in combination with the drawings. It can be understood that these drawings only depict several embodiments of the content of this application, and therefore should not be considered as limiting the scope of the content of this application. By adopting the drawings, the content of this application will be explained more clearly and in detail.

FIG. 1 shows a flowchart of a method 100 for automatically cooking food according to one embodiment of the present application;

FIG. 2 shows a flowchart of a method 200 for automatically cooking food according to another embodiment of the present application;

FIG. 3 shows a flowchart of a method 300 for automatically cooking food according to another embodiment of the present application;

FIG. 4 shows a flowchart of a method 400 for automatically cooking food according to another embodiment of the present application;

FIG. 5 shows a flowchart of a method 500 for automatically cooking food according to another embodiment of the present application;

FIG. 6 shows a flowchart of a method 600 for automatically cooking food according to another embodiment of the present application;

FIG. 7 shows a schematic diagram of an apparatus 700 for automatically cooking food according to another embodiment of the present application.

### DETAILED DESCRIPTION

In the following detailed description, reference is made to the drawings constituting a part thereof. In the drawings, similar symbols usually indicate similar components, unless context dictates otherwise. The illustrative embodiments described in the detailed description, drawings, and claims are not meant to be limiting. Without departing from the spirit or scope of the subject matter of the present application, other embodiments may be adopted, and other changes may be made. It can be understood that various aspects of the application generally described in the application and illustrated in the drawings can be configured, replaced, combined, and designed with various different configurations, and all of these clearly constitute part of the application.

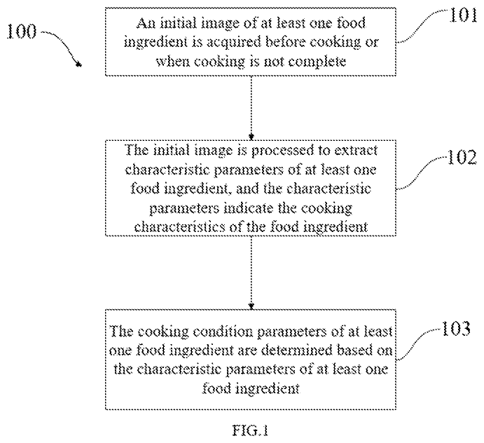

FIG. 1 shows a flowchart of a method 100 for automatically cooking food according to an embodiment of the present application. As shown in FIG. 1, in step 101, an initial image of at least one food ingredient is acquired. It should be noted that the food ingredients may be any ingredients used for cooking dishes. In some embodiments, the food ingredients are main dishes and side dishes for cooking dishes. In other embodiments, the food ingredients also include seasonings and ingredients required for cooking dishes. Taking cooking Kung Pao chicken as an example, at step 101, an initial image of main dishes and side dishes such as chicken, peanuts, green onions can be acquired, and the initial image of ingredients or seasonings used (such as water starch, bean paste, green onion, and ginger) can also be acquired. In some embodiments, the initial image is acquired before cooking, for example, when the food ingredients are still in the cooking container and have not been taken out. In other embodiments, the initial image is acquired at a certain stage of the cooking process, for example, when the food ingredients are placed in the cooking container for cooking. In still other embodiments, the initial image may also be acquired when the cooking of the food ingredients is temporarily suspended to determine whether the dish is qualified or whether further processing is required, and so on.

In step 102, the initial image to extract characteristic parameters of at least one food ingredient is processed. The characteristic parameters indicate the cooking characteristics of the food ingredients. Specifically, the above-mentioned characteristic parameters may be the name, type, bulk density, weights, color, texture, shape, size, freshness, humidity, color, doneness, surface burnt, color changes of different parts of the food ingredients, and the relationship between a plurality of processing objects of the food ingredients and so on. In some embodiments, only one characteristic parameter is extracted. For example, when the acquired initial image is an image of tofu in an ingredient container, the weight of tofu can be extracted from the image (the specific method will be described in detail below). In some embodiments, some characteristic parameters are extracted to determine one or more cooking characteristics of the food ingredients. For example, when the acquired initial image is a green vegetable being cooked in a cooking container, the color, texture, shape, and humidity of the green vegetable can be extracted from the image to determine the degree of doneness of the green vegetable, and whether there is overheating. It should be noted that, in some embodiments, the characteristic parameter is the image pixel itself, and the relevant characteristics of the food ingredients can be determined by analyzing the image pixel.

In some embodiments, the extraction of the characteristic parameters of the food ingredients in step 102 is implemented by deep learning or other artificial neural network algorithms. Taking cooking Sichuan style double-cooked pork as an example, the images of each cooking process of the raw pork belly when it is completely raw, medium rare, medium, medium well, well are manually labeled based on the images acquired during the cooking process of 20 times of cooked Sichuan style double-cooked pork, and it defines 5 categories of pork belly in Sichuan style double-cooked pork (respectively category 1, category 2, category 3, category 4, category 5). Then the labeled images are used to train a deep learning neural network (such as Mask R-CNN) to obtain a model W so that it can reproduce the label classification. During operation, the image of the pork belly acquired at moment t₁ during the cooking process is input into the model W to determine the type of doneness of the pork belly at moment t₁.

Considering that the acquired image of food ingredients can only show a part of the food ingredients, some food ingredients may also be hidden by other food ingredients that are cooked together. Therefore, in some embodiments, in step 101, images of at least one food ingredient at multiple adjacent moments (for example, t₁, t₂, and t₃) in the cooking process are acquired, and then the above-mentioned multiple images are processed in step 102 to extract the characteristic parameters of the food ingredients at t₁, t₂ and t₃ respectively. And based on the above characteristic parameters, the average characteristic parameters or other statistical values of characteristic parameters of the food ingredients from t₁ to t₃ are acquired to more accurately reflect the cooking characteristics of the food ingredients during the period and then the cooking condition parameters of the cooking process are adjusted.

In other embodiments, when the food ingredients in the initial image are still in the ingredient container, the characteristic parameters can also be identified by the identification information on the ingredient container, such as scanning and identifying the two-dimensional code or barcodes on the ingredient container. The database or server can be accessed to acquire the characteristic parameters of the food ingredients in the ingredient container by identifying a two-dimensional code or barcode.

In other embodiments, in step 102, additional characteristic parameters of the food ingredients such as one or more of the temperatures of the ingredients, the temperature of the pot, and the pressure of the pot are extracted by using other sensors. Correspondingly, the additional characteristic parameters and the characteristic parameters can jointly indicate the cooking state of the food ingredients for the selection and determination of subsequent cooking conditions.

In step 103, the cooking condition parameters for the food ingredients are determined based on the characteristic parameters of at least one food ingredient as mentioned above or the characteristic of the food ingredients determined therefrom. The cooking condition parameters may be any condition parameters that affect the cooking of the dish, specifically, for example, heating temperature, heating power, heating time, whether to add water, the amount of water added, the type and amount of seasonings added, the stir-frying time, the stir-frying speed, the extent of the stir-frying, whether the pot is covered, the duration of the lid coverage, whether to blow, the force of blow or the duration of the blow. Taking the initial image acquired as the image of tofu in the ingredient container as an example, the heating temperature, heating power, heating time, additional amount, and type and amount of seasonings for cooking tofu can be determined based on the weight of tofu. Taking the initial image acquired as the image of green vegetables as an example, the heating temperature, heating power, or the heating time can be adjusted, water can also be added accordingly when the green vegetables are over-heated. In some embodiments, in step 103, the cooking condition parameters for the food ingredients can be determined based on the characteristic parameters through deep learning or other artificial neural network algorithms. For example, in some embodiments, the deep learning neural network is trained using multiple cooking condition parameters in multiple qualified cooking processes of at least one food ingredient as a sample. Taking the cooking of Sichuan style double-cooked pork as an example, the characteristic parameters of the double-cooked pork corresponding to each cooking condition parameter are manually labeled during multiple (such as 20, 30, or 100) successful cooking of Sichuan style double-cooked pork, and the labeled samples are trained deep learning neural networks (such as Mask R-CNN) to obtain model X so that it can reproduce label classification. The characteristic parameter acquired at time t₁ is input into the model X during operation and the preferred cooking condition parameters or adjusted parameters under the characteristic parameters can be determined. In other embodiments, step 103 is implemented through a preset program.

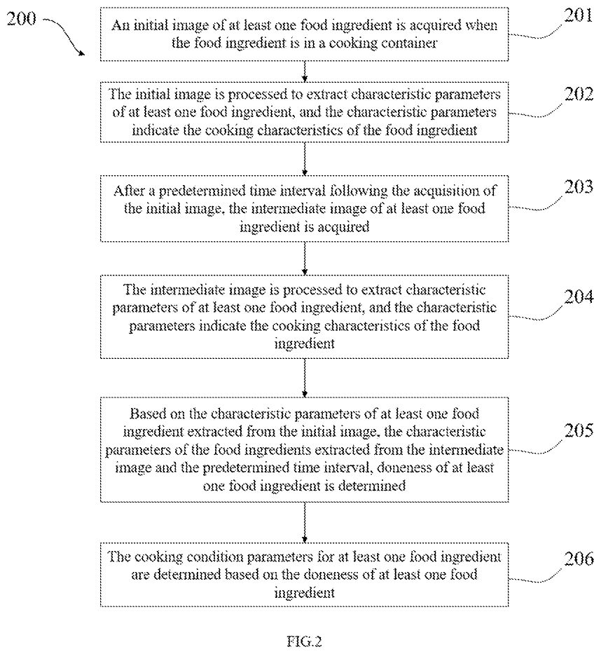

FIG. 2 shows a flowchart of a method 200 for automatically cooking food according to another embodiment of the present application. Steps 201 and 202 of method 200 are similar to steps 101 and 102 of method 100 and will not be described in detail here. In step 203, after a predetermined time interval of acquiring the initial image, an intermediate image of the food ingredients is acquired again. In some embodiments, the predetermined time interval may be any length less than the expected remaining cooking time, for example, 1/30, 1/10, ⅕, or ½ of the expected remaining cooking time. In some embodiments, the predetermined time interval may be set to be from the moment of the initial image acquisition until when an important characteristic parameter of the food ingredients is predicted to occur under the current cooking, or until certain change in characteristic parameter occurs (for example, overburnt or overheated). It should be noted that the images acquired in steps 201 and 203 of method 200 are all images of the food ingredients during cooking, in some embodiments, the initial image acquired in step 201 may also be the images of the food ingredients before cooking, for example, the initial image may be acquired when the food ingredients are still in the ingredient container and not taken out. It should be noted that, in some embodiments, the images acquired in step 201 and step 203 may be images of food ingredients before cooking or in a preprocessing (for example, defrosting) process, so that the cooking condition parameters during the food ingredients preprocessing can be determined based on parameters of food ingredients from image extraction, such as adjusting the heating time or heating power for defrosting. Defrosting can also be a step in cooking.

Step 204 is similar to step 102 or 202 and will not be described in detail here. In step 205, based on the characteristic parameters of the food ingredients extracted from the initial image in step 202, the characteristic parameters of the food ingredients extracted from the intermediate image in step 204, and a predetermined time interval, the doneness of at least one food ingredient is determined. Therefore, in the method 200, the characteristic parameters extracted in step 202 and step 204 can be any characteristic parameters that can reflect the doneness of the food ingredients, including but not limited to the name, type, color, texture, shape, size, and freshness of the food ingredients, temperature, humidity, color, surface burnt, color changes of different parts.

Specifically, in some embodiments, the speed of doneness of food ingredients can be determined by analyzing the respective surface burnt or color of the food ingredients in the initial image and the intermediate image, and a predetermined time interval. In some embodiments, the speed of doneness of food ingredients can be determined by judging the size change (for example, becoming larger or smaller) of the food ingredients in the initial image and the intermediate image, and a predetermined time interval. In some embodiments, multiple characteristic parameters are considered at the same time to determine the speed of doneness of the food ingredients, such as, color, texture, shape, or surface burnt of food ingredients of different types, sizes, and freshness at different doneness levels are considered comprehensively, and predetermined time interval to determine the speed of doneness of the food ingredients. In some embodiments, at least one of the type, size, and freshness of the food ingredients, the color, texture, shape, or level of surface burnt of the food ingredients in the initial image and the intermediate image, and the predetermined interval is considered to more accurately determine the speed of doneness of food ingredients.

In step 206, the cooking condition parameters for the food ingredients are determined based on the speed of doneness of the food ingredients. The cooking condition parameters can be any condition parameter that affects the speed of doneness of the food ingredients. Specifically, such as heating temperature, heating power, continuous heating time, whether to add water, the amount of added water amount, stir-frying time, stir-frying speed, stir-frying frequency, the extent of stir-frying, whether to cover the pot, the duration of the lid coverage, whether to blow, the force of blast, or the duration of the blow. Specifically, in some embodiments, the heating temperature or heating power of the food ingredients are determined based on the speed of doneness of the food ingredients. When the speed of doneness is too fast, the heating temperature or heating power is lowered, and when the speed of doneness is too slow, the heating temperature or heating power is increased. In other embodiments, when the speed of doneness of the food ingredients is too fast, turn off the blower or turn down the blower, and when the speed of doneness is too slow, turn on the blower or turn up the blower. In still other embodiments, when the speed of doneness of the food ingredients is too fast, open the lid of the cooking container, and when the speed of doneness is too slow, cover the lid of the cooking container. In some embodiments, when the speed of doneness of the food ingredients is too fast, shorten the originally set continuous heating time to avoid the overheating, and when the real cooking spee the speed of doneness is too slow, extend the originally set continuous heating time to ensure that the dish is not cooked. Taking the cooking of Sichuan style double-cooked pork as an example, if the pork belly at t₁ is determined to be medium rare, and the pork belly at t₂ after a longer time is determined to be medium, the speed of doneness of the pork belly may be considered too slow. Based on the speed of doneness at this moment, the cooking heating power and stir-frying frequency can be correspondingly increased to increase the speed of doneness

It is noted that food ingredients for cooking dishes usually include multiple types. For example, the dish Sichuan style double-cooked pork may include pork belly and garlic sprouts. Different food ingredients may have different speeds of doneness due to different cooking conditions. Therefore, different combinations of different types of cooking condition parameters may have different effects on the doneness of food ingredients. In step 206, a more suitable combination of cooking condition parameters can be determined based on different speeds of doneness of different types of food ingredients. Still taking Sichuan style double-cooked pork as an example, after step 205, it is determined that the doneness of the pork belly is higher than that of the garlic sprouts: Compared with adding water, increasing the heating temperature has a greater impact on the doneness of the pork belly (compared to garlic sprouts), in step 206, lower the heating temperature and add water appropriately instead of maintaining the heating temperature and reducing the amount of water added.

The images at two moments are only acquired in the method 200 as shown in the figure, in some embodiments, images at more moments can be acquired to monitor the doneness and cooking speed of food ingredients in real-time and adjust the heating power, heating time, and other cooking condition parameters accordingly to truly achieve power control like a chef, ensuring that the finished dishes have the best taste and color, and improving the consistency of the quality of the dishes effectively.

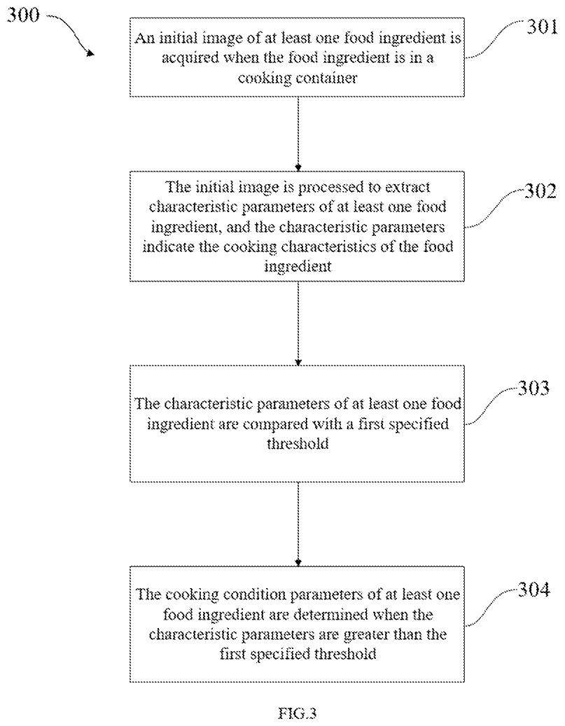

FIG. 3 shows a flowchart of a method 300 for automatically cooking food according to another embodiment of the present application. Among them, step 301 and step 302 are similar to steps 101 or 201 and 102 or 202 and will not be described in detail here. In step 303, the characteristic parameters of the food ingredients extracted from the initial image are compared with a first specified threshold, and then in step 304, the cooking condition parameters or combinations of the food ingredients are determined based on the comparison result of the above characteristic parameters and the first specified threshold. It should be noted that the characteristic parameters of the food ingredients acquired in step 302 may be any parameter indicating the characteristic parameters of the food ingredient. In some embodiments, the characteristic parameter acquired at step 302 is freshness. When the freshness is greater than the corresponding threshold, it means that the food ingredient is raw, in step 304, the cooking condition parameters (such as increasing heating power, the stir-frying frequency, extending the heating time, turning on the blower, or turning up the blower) are adjusted. Instead, when the doneness of the surface burnt, color, or texture is greater than the corresponding threshold, it means that the food ingredients are too old or overheated, in step 304, turning down the heating power, heating time, turning off the blower to avoid the above problems. It should be noted that in step 304, the cooking condition parameter of the food ingredient is adjusted when the characteristic parameter of the food ingredients is greater than the first specified threshold. In some embodiments, the cooking condition parameter is adjusted when the characteristic parameter of the food ingredients is smaller than the first specified threshold. For example, when the humidity of the food ingredients is less than the first specified threshold, it can be determined that the food ingredients are too dry, and the cooking condition parameter in step 304 is adjusted to solve the above problem, such as adding water, increasing the amount of added water.

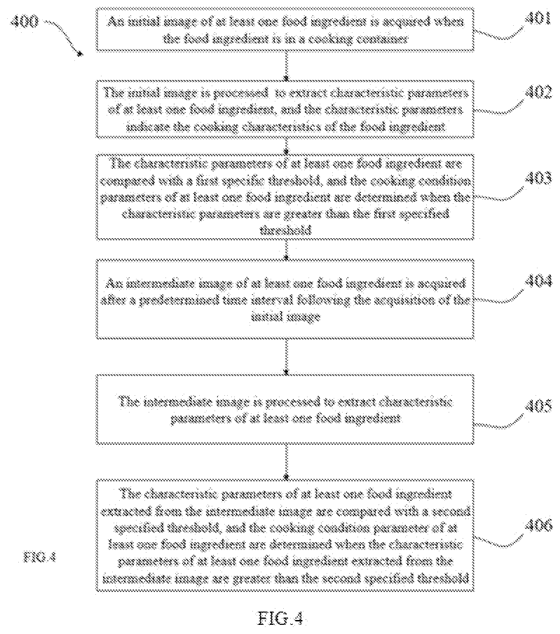

FIG. 4 shows a flowchart of a method 400 for automatically cooking food according to another embodiment of the present application, and steps 401 to 403 thereof correspond to steps 301 to 304 of the method 300, which will not be described in detail here. Steps 404 and 405 are similar to steps 203 and 204 of method 200 and will not be described in detail here. In step 406, the characteristic parameter of the food ingredients extracted from the intermediate image is compared with a second specified threshold, and when the characteristic parameter is greater than the second specified threshold, the cooking condition parameter for the food ingredients is determined. The adjustment of the cooking condition parameter in step 406 is similar to the adjustment in step 304 in method 300, and the characteristic parameter may also be any parameter indicating the characteristics of the food. Specifically, in some embodiments, in step 402, the characteristic parameter extracted from the initial image of the food ingredients at time t₁ is the level of surface burnt, color, or doneness. When it is greater than the first threshold, it indicates that the food ingredients are too old or overheated, the cooking condition parameters are adjusted to solve the problem in step 403, (for example, reducing the heating power, heating time, turning off the blower or turning down the force of the blower). Then in steps 404 and 405, in the intermediate image acquired at time t₂ of the food ingredients, the level of surface burnt, color, or doneness of the food ingredients at this moment are also extracted, and compared with the second threshold, if it is greater than the second threshold, it indicates that the previously adjusted cooking condition parameters did not have the corresponding effect, so in step 406, the cooking condition parameters can be further adjusted (for example, reducing the heating power, heating time, turning off the blower or reducing the force of the blower) to solve the problem of over-dry or overheated.

For example, in some other embodiments, in step 402, the characteristic parameter extracted from the initial image acquired at time t₁ is humidity. When it is greater than the first threshold, the food ingredients are too dry, and then the cooking condition parameter is adjusted in step 403, such as adding water and increasing the amount of added water to solve the above problems. In step 404, extracted from the food ingredients intermediate image at time t₂ acquired in the current humidity of the food ingredients, when it is greater than the second threshold value, indicating that the food ingredients are still in an over-dry state, and therefore, in step 406, the cooking condition parameters can be adjusted, such as adding water, increasing the amount of added water to solve the above problems.

Similarly, the images at two moments are acquired at method 400 as shown in the figures, but in some embodiments, images at multiple moments can be acquired to achieve a real-time comparison of food ingredients with corresponding thresholds, and the cooking condition parameters are adjusted to track the adjustment effect of the previous cooking condition parameters in real-time and make new adjustments in time to finally achieve the desired adjustment result.

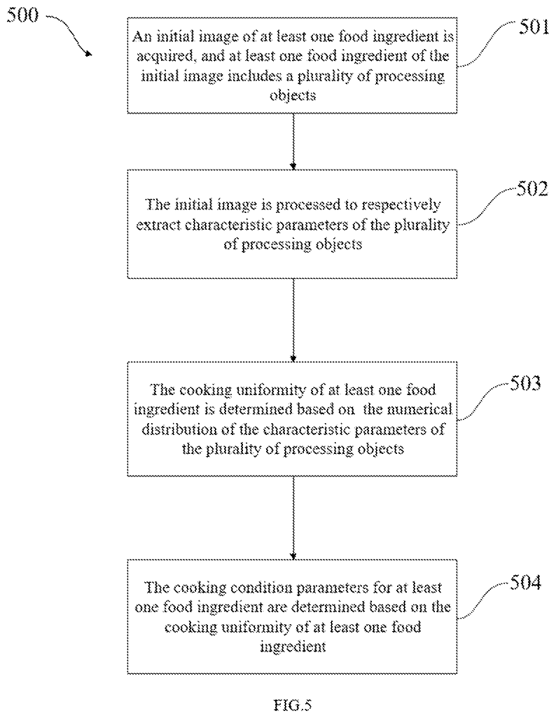

FIG. 5 shows a flowchart of a method 500 for automatically cooking food according to another embodiment of the present application. In step 501, an initial image of at least one food ingredient is acquired, wherein at least one food ingredient includes a plurality of processed objects. In some embodiments, the plurality of processing objects may belong to the same food ingredient, for example, multiple slices of pork belly for frying Sichuan style double-cooked pork. In other embodiments, the plurality of processing objects may also be different types of food ingredients, such as slices of shiitake mushrooms, slices of oyster mushrooms, and slices of jumbo-mushrooms in the stir-fried mixed mushrooms.

In step 502, the characteristic parameters of the plurality of processing objects are extracted by processing the initial image. This step is similar to the feature parameter extraction step in the methods 100, 200, 300, and 400, and will not be described in detail here. In step 503, the cooking uniformity of the food ingredients is determined based on the numerical distribution of the characteristic parameters of the plurality of processing objects. Take the stir-fried mixed mushrooms as an example, where the extracted characteristic parameters are parameters that indicate their doneness (such as color, texture, shape, or surface burnt). If the doneness of the mushrooms is scattered, for instance half of them being only medium rare while the other half is already fully cooked, then it can be considered that the current cooking uniformity is relatively low. Conversely, if the distribution of the doneness of slices of mushroom is relatively concentrated, for example, 70% of the slices are medium and 30% are medium well, it can be considered that the current uniformity is relatively high.

Subsequently, in step 504, based on the cooking uniformity of the one or more food ingredients obtained in step 503, the cooking condition parameters for the food ingredients are determined. Continuing to take the above stir-fried mixed mushrooms as an example, if the cooking uniformity is low, the cooking condition parameters need to be adjusted to change the cooking uniformity. Specifically, in some embodiments, the cooking uniformity of the plurality of processed objects of the food ingredients is adjusted based on at least one r-frying time, stir-frying speed, stir-frying frequency, and extent of the stir-frying.

The image at one moment is acquired at method 500 as shown in the figure, however, in some embodiments, images of multiple moments can be acquired to monitor the cooking uniformity of food ingredients at different moments in real-time, and then cooking condition parameters are determined to realize the real-time adjustment of cooking uniformity.

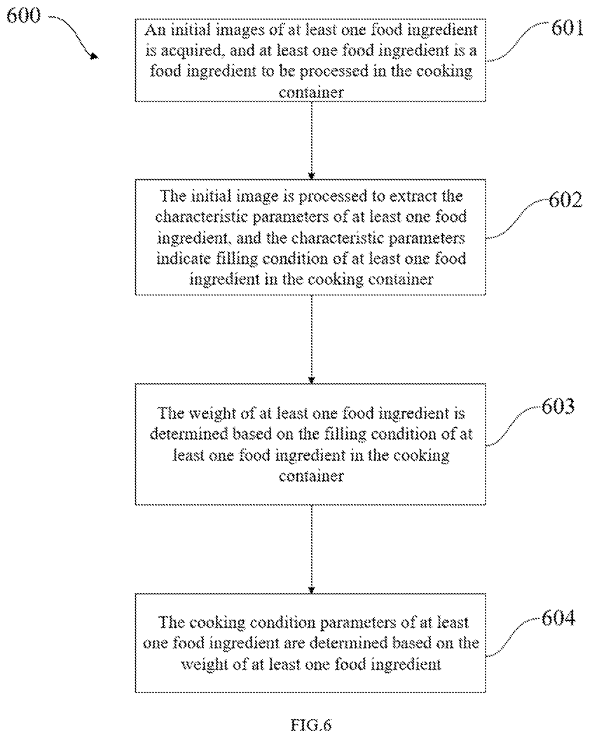

FIG. 6 shows a flowchart of a method 600 for automatically cooking food according to another embodiment of the present application. In step 601, an initial image of one or more food ingredients to be processed that are still in the cooking containers is acquired. In step 602, the characteristic parameters of the food ingredients are extracted by processing the initial image. This step is similar to the characteristic parameters' extraction step of the above method. The characteristic parameters can be any parameter indicating the characteristics of the food ingredients to be processed, for example, the name, type, bulk density, weight, color, texture, shape, size, freshness, humidity, color, doneness, color changes of different parts and the relationship between the processing objects of the plurality food ingredients, etc. As mentioned above, the above-mentioned characteristic parameters can also be realized from the initial images by identifying the identification information (such as a two-dimensional code, a barcode) on the ingredient container.

In some embodiments, the characteristic parameters include the filling condition of the food ingredients in the cooking container. In step 603, the weight of the food ingredients is determined based on the filling condition of the food ingredients in the cooking container. In some embodiments, the bulk density of the food ingredients can be determined by the type of the food ingredients and in combination with the filling volume of the cooking container, the weight of the food ingredients can be determined. In some embodiments, the weight of the food ingredients when it is filled can be determined by the type of food ingredients, and then in combination with its current filling ratio in the cooking container to determine the weight of the food ingredients.

In step 604, the cooking condition parameters of the food ingredients are determined based on the weight of the food ingredients extracted in step 603. The cooking condition parameters may be any parameter that affects the cooking process related to the weight of the food ingredients, including but not limited to heating. temperature, heating power, heating time, whether to add water, the amount of water added, the type and number of seasonings added, stir-frying time, stir-frying speed, stir-frying frequency, the extent of stir-frying, whether to cover the pot, the duration of the lid coverage, whether to blow, the force of the blow and the duration of blow, etc. Specifically, in some embodiments, based on the weight of the food ingredients obtained in step 603, the heating temperature, heating power, or heating time of the food ingredients are determined or adjusted in step 604 to ensure that the food ingredients can be fully heated without overheating. In other embodiments, the stir-frying frequency of the food ingredients is determined or adjusted based on the weight of the food ingredients to realize full frying of the food ingredients under energy saving. In some embodiments, the amount of added water is determined or adjusted based on the weight of the food ingredients to ensure the dry humidity and flavor of the final dish.

In some embodiments, the steps of processing images at the above methods 100 to 600 to extract characteristic parameters of food ingredients may be implemented by a deep learning neural network. In some embodiments, the objective function of the model training in the deep learning neural network includes one or more of the style, color, aroma, flavor, the ratio of main and auxiliary materials, and heat. Specifically, in some embodiments, the training objective function is determined by manual observation and tasting, or by another pre-trained deep learning neural network model.

Specifically, in some embodiments, the deep learning neural network is trained by using images acquired at multiple moments during multiple qualified cooking of at least one food ingredient as samples. Take Sichuan style double-cooked pork as an example. First, based on the images of 20 successful Sichuan style double-cooked pork cooking processes, the images of the pork belly as different categories, such as the images that pork belly is completely raw, medium rare, medium, medium well or fully cooked are manually labeled to define the 5 levels of food ingredient in the Sichuan style double-cooked pork recipe (rare, medium rare, medium, medium well, done). Then the labeled images are used to train a deep learning neural network (such as Mask R-CNN) to obtain a model W so that it can reproduce the label classification. When running, the image in the pot acquired at time t₁ is input into the model W. If more than 50% of the detected objects in the image are considered medium rare, the original recipe (default program) is executed as planned for this cooking. If more than 50% of the detected objects in the image are recognized as rare, it means that this cooking is off the standard program, and if more than 50% of the detected objects in the image are recognized as medium, it means that the second cooking is overheat than the standard procedure.

In some embodiments, the determination of the cooking condition parameters for one or more food ingredients at methods 100 to 600 based on the characteristic parameters of the food ingredients are also implemented through a deep learning neural network. As described above, in some embodiments, the deep learning neural network can be trained as a sample based on the determination or adjustment of the corresponding suitable or effective cooking parameters for different characteristic parameters in the actual cooking process. Taking the above-mentioned stir-fried mixed mushrooms as an example, according to the actual cooking process, for different cooking uniformity, each cooking condition parameter or its adjustment is labeled, and the labeled samples are used to train the deep learning neural network to obtain the model X so that it can reproduce the label classification. During the actual execution of the method, the cooking uniformity at time t₁ is input into the model X, and the model X can feedback the preferred cooking condition parameters or their adjustments under the cooking uniformity. In other embodiments, a preset program is implemented in step 103.

In some other embodiments, the deep learning neural network can also be trained through images and parameter samples collected at different moments during the current cooking process. For example, in the cooking process of the above-mentioned stir-fried mixed mushrooms, the cooking uniformity of the mixed mushrooms collected at time t₁ is input into the model X to determine the cooking condition parameters for the mixed mushrooms, such as turning down the heating power by 50%. Subsequently, the degree of cooking uniformity at time t₂ is extracted to evaluate the effect of adjusting the cooking condition parameters of the previous food ingredients, and the evaluation result is used to optimize model X.

In some embodiments, the deep learning neural network is trained using multiple weighing results of at least one food ingredient as the actual weight value. For example, taking the weight value of tofu in the cooking container as an example, first, the filling image of tofu in the cooking container is acquired, then the tofu in the cooking container is weighed to get the actual gram weight value, and the image is manually labeled, such as an image of tofu that occupies ¼ volume of the ingredient container, an image of tofu that occupies ½ volume of the ingredient container, an image of tofu that occupies ¾ volume of the ingredient container, and an image of tofu that occupies the entire volume of the ingredient container to define the material box tofu images corresponding to multiple weight values of tofu in the ingredient container. Then, the labeled images are used to train a deep learning neural network (such as Mask R-CNN) to obtain model Y, so that it can reproduce the label classification.

In some embodiments, the architecture of the deep learning neural network may be at least one of object detection technology, RetinaNet, Faster R-CNN, and Mask R-CNN. In some embodiments, the algorithm of the deep learning neural network includes ResNet, Inception-ResNet, Feature Pyramid Network, Fully Convolutional Network, or Focal Loss.

In some embodiments, the underlying tools of the deep learning neural network include TensorFlow, Caffe (Convolutional Architecture for Fast Feature Embedding), Theano, PyTorch, Torch&Overfeat, MxNet, Keras, and so on.

TensorFlow is a large-scale machine learning framework on a heterogeneous distributed system with good portability and supports a variety of deep learning models. Caffe is a common deep learning framework, mainly used in video and image processing applications. Theano is a Python database dedicated to defining, optimizing, and evaluating mathematical expressions with high efficiency and is suitable for multi-dimensional arrays. PyTorch is a Python-first deep learning framework that can implement tensors and dynamic neural networks based on powerful GPU acceleration. Torch is an early scientific computing framework that supports most machine learning algorithms. There are currently four versions, Torch 1, Torch 3, Torch 5, and Torch 7 respectively. MxNet is a deep learning framework designed for efficiency and flexibility. It attracts the advantages of many different frameworks and adds more new functions, such as more convenient multi-card and multi-machine distributed operation. Keras is a deep learning database based on Theano and TensorFlow. It is written in pure Python and is based on Tensorflow, Theano, and CNTK backends. It is a high-level neural network API.

In some embodiments, the step of determining the cooking condition parameters for the food ingredients based on the characteristic parameters of one or more food ingredients is determined according to a program programmed in advance based on the previous cooking experience.

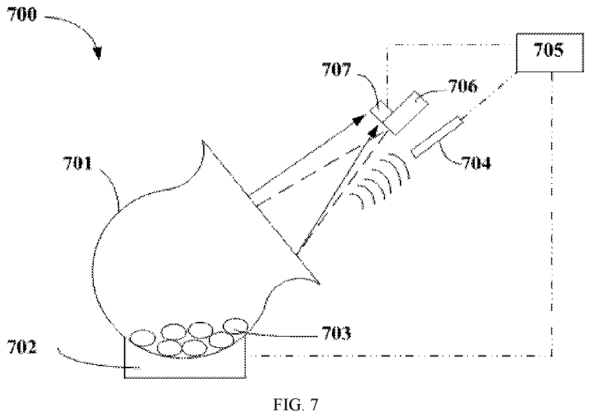

FIG. 7 shows a schematic diagram of an apparatus 700 for automatically cooking food according to another embodiment of the present application. As shown in the figure, device 700 includes a cooking container 701, a processor 705, and an image processor 707.

In some embodiments, the image sensor 707 is a light guide tube or a solid-state image sensor, and the image sensor is generally disposed toward the opening of the cooking container 701 for acquiring an image of the food ingredients 703 in the cooking container 701. Since the cooking device, 700 is usually in a high-temperature enclosed environment, in some embodiments, the image sensor 707 is an industrial camera. In some embodiments, the position of the image sensor 707 relative to the cooking container 701 is adjustable to acquire an image of different positions in the cooking container 701. In some embodiments, during the cooking process, the included angle between the opening of the cooking container 701 and the vertical is 0° to 90°. Wherein, in some embodiments, the included angle between the opening of the cooking container 701 and the vertical direction is an adjustable included angle, and the included angle can be adjusted between 0 degrees and 180 degrees. In some embodiments, the pot body of the cooking container 701 includes a transparent part (not shown in the figure), so that when the cooking container 701 is closed, the image sensor 707 can also acquire the image of food ingredients 703 in the cooking container 701 through the transparent part. Although the image sensor 707 shown in the figure is mainly used to acquire the image of the actual food ingredients 703 in the cooking container 701. In some embodiments, the image sensor 707 may also be used to acquire image of the food ingredients 703 that are not in the cooking container 701, for example, an image of food ingredients 703 in the ingredient container.

In addition, since there is usually insufficient light in the cooking container 701, in some embodiments, the device 700 further includes a lighting device 706 that is next to the image sensor 707 in the figure, in some embodiments, the lighting device 706 may also be at any other position that is convenient for illuminating the food ingredients 703. Specifically, in some embodiments, the position of the illumination position 706 relative to the position of the cooking container 701 is also adjustable to illuminate different positions in the cooking container 701. In some embodiments, the lighting device 706 is a spotlight, while in other embodiments, the lighting device 706 is a shadowless lamp.

As shown in the figure, the processor 705 is in communication connection with the image sensor 707, so that the image of the food ingredients 703 acquired by the image sensor 707 can be transmitted to the processor 705. The processor 705 processes the image to extract the characteristic parameters of the food ingredients 703. For the method of extracting the characteristic parameters of the food ingredients 703, refer to the corresponding steps in the above-mentioned methods 100, 200, 300, 400, 500, and 600. After acquiring the characteristic parameter of the food ingredients 703, the processor 705 determines the cooking condition parameter for the food ingredients 703 based on the characteristic parameters. Regarding the method of determining the cooking condition parameter for the food ingredients 703 based on the characteristic parameters, refer to the corresponding steps in the methods 100, 200, 300, 400, 500, and 600 described above. It should be noted that processor 705 is configured to execute a deep learning algorithm to train a neural network to implement the above steps. The deep learning algorithm may include ResNet, Inception-ResNet, Feature Pyramid Network, Fully Convolutional Network, or Focal Loss, and the neural network may be at least one of object detection technology, RetinaNet, Faster R-CNN, and Mask R-CNN.

As shown in FIG. 7, device 700 further includes a cooking mechanism 702 to perform a cooking operation on the food ingredients 703 in the cooking container 701. In some specific embodiments, the cooking mechanism 702 is in communication connection with the processor 705, to perform specific cooking operations on the food ingredients 703 in the cooking container 701 in real-time based on the cooking condition parameters from the processor 705. Although the cooking mechanism 702 as shown in the Figure is an exemplary heating mechanism, in actual operation, the cooking mechanism 702 may also include any other mechanisms or devices for cooking food ingredients, such as heating devices, stirring devices, stir-frying device, timing device, temperature control device, power adjustment device, water adding device, oil adding device, adding seasoning device, thickening device or vegetable delivery device, etc.

Continuing to refer to FIG. 7, the device 700 further includes a temperature sensor 704 for measuring the temperature of the pot body of the cooking container 701. In some embodiments, the temperature sensor is an infrared temperature sensor or an infrared sensor array. Although it is not shown in the figure, in some embodiments, the device 700 further includes a range hood (not shown in the figure), to suck the oil fume generated in the cooking container 701 in time. In some embodiments, the position of the range hood is set so that the direction in which the smoke is sucked and the alignment direction of the image sensor 707 are at a certain angle, such as 45 degrees to 60 degrees to prevent the oil smoke from affecting the imaging of the image sensor 707. In some embodiments, the processor 705 is further configured to process the image of the image sensor 707 to determine the smoke interference in the cooking container and adjust the blow force based on the smoke interference.

It should be noted that although the sensor involved in the method and device described in detail in the context is an image sensor, based on the same principle, the sensor can also be replaced with other types of sensors, such as olfactory sensors or auditory sensors.

It should be noted that although several modules or sub-modules of the apparatus 700 for automatically cooking food are mentioned in the above detailed description, this division is only exemplary and not mandatory. In fact, according to the embodiments of the present application, the features and functions of two or more modules described above can be embodied in one module. Conversely, the features and functions of a module described above can be further divided into multiple modules to be embodied. In some embodiments, the device for automatically cooking food may also be a device with a structure different from that shown in FIG. 7, for example, the device for automatically cooking food may be an automatic stir-frying machine, steaming oven, steaming pot, Toaster, combi steamer, microwave or oven, etc.

Those skilled in the art can understand and implement other changes to the disclosed embodiments by studying the description, the disclosed content, the drawings and the appended claims. In the claims, the word “comprise” does not exclude other elements and steps, and the word “a” and “one” do not exclude plurals. In the actual application of this application, one part may perform the functions of multiple technical features cited in the claims. Any reference signs in the claims should not be construed as limiting the scope.

1. A method for automatically cooking food, comprising:
acquiring an initial image of a variety of food ingredients in a cooking container, the initial image being acquired before cooking or when the cooking is not complete;
acquiring an intermediate image of the variety of food ingredients in the cooking container after a predetermined time interval;
processing the initial image and the intermediate image to extract characteristic parameters of the food ingredients, and the characteristic parameters of the food ingredients indicate the cooking characteristics of the food ingredients;
determining cooking condition parameters for the variety of food ingredients based on characteristic parameters of the food ingredients;
wherein, the processing of the initial image and the intermediate image to extract the characteristic parameters of the food ingredients comprises:
respectively determining doneness speed of at least two kind of food ingredients among the variety of food ingredients based on the initial image and intermediate image.

2. (canceled)

3. (canceled)

4. (canceled)

5. (canceled)

6. The method according to claim 1, wherein the determination of the cooking condition parameters for the variety of food ingredients based on the characteristic parameters of the food ingredients comprises:
comparing the characteristic parameters of the food ingredients with a first specified threshold;
determining the cooking condition parameters of the plurality of food ingredients when the characteristic parameters of the food ingredients are greater than the first specified threshold.

7. The method according to claim 6, wherein: the determination of the cooking condition parameters of the variety of food ingredients based on the characteristic parameters of the food ingredients further comprises
comparing the characteristic parameters of the food ingredients extracted from the intermediate image with a second specified threshold;
determining the cooking condition parameter for the variety of food ingredients when the characteristic parameters of the food ingredients extracted from the intermediate image are greater than the second specified threshold.

8. The method according to claim 1, wherein the initial image of at least one food ingredient comprises a plurality of processed objects, the method further comprises:
processing the initial image to extract characteristic parameters of the plurality of processing objects respectively;
wherein, the determination of the cooking condition parameters of at least one food ingredient based on the characteristic parameters of at least one food ingredient comprises:
determining the cooking uniformity of at least one food ingredient based on the numerical distribution of characteristic parameters of the plurality of processing objects;
determining the cooking condition parameters for the at least one food ingredient based on the cooking uniformity of the at least one food ingredient.

9. The method according to claim 8, wherein the determination of the cooking condition parameter for at least one food ingredient based on the cooking uniformity of at least one food ingredient comprises:
determining at least one of the stir-frying time, the stir-frying speed, the stir-frying frequency, and the extent of stir-frying of at least one food ingredient based on the cooking uniformity of the at least one food ingredient.

10. (canceled)

11. (canceled)

12. (canceled)

13. The method according to claim 1, wherein processing initial image to extract characteristic parameters of the food ingredients or determining the cooking condition parameters of the variety of food ingredients based on the characteristic parameters of the food ingredients are implemented by deep learning neural network.

14. The method according to claim 13, wherein the deep learning neural network uses supervised learning to obtain one or more characteristic parameters of the food ingredients or to obtain one or more cooking condition parameters for the food ingredients by labeling one or more training samples.

15. The method of claim 13, wherein the deep learning neural network is trained using the image acquired at multiple moments during multiple qualified cooking of at least one food ingredient as samples.

16. The method of claim 13, wherein the deep learning neural network is trained with the results of multiple weighing of the food ingredients as the actual weights of the ingredients.

17. The method of claim 13, wherein the architecture of the deep learning neural network is at least one of object detection technology, RetinaNet, Faster R-CNN, and Mask R-CNN.

18. The method of claim 13, wherein the algorithm used by the deep learning neural network comprises ResNet, Inception-ResNet, Feature Pyramid Network, Fully Convolutional Network or Focal Loss.

19. (canceled)

20. An automatic cooking device for automatically cooking food comprising:
an image sensor;
a processor configured to perform the following steps:
acquiring an initial image of a variety of food ingredients in a cooking container by the image sensor, the initial image being acquired before cooking or when the cooking is not complete;
obtaining the intermediate image of the variety of food ingredients in the cooking container after a predetermined time interval;
processing the initial image and the intermediate image to extract characteristic parameters of the food ingredients, wherein the characteristic parameters of the food ingredients indicate the cooking characteristics of the food ingredients;
determining cooking condition parameters for the variety of food ingredients based on characteristic parameters of the food ingredients;
wherein, the processing of the initial image and the intermediate image to extract the characteristic parameters of the food ingredients comprises:
respectively determining doneness speed of at least two food ingredients among the plurality of food ingredients based on the initial image and intermediate image.

21. (canceled)

22. (canceled)

23. The automatic cooking device according to claim 20, wherein the device further comprises a cooking container for holding the variety of food ingredients for cooking.

24. The automatic cooking device according to claim 23, wherein the cooking container comprises an opening, and the orientation of the opening forms an angle between 0 and 90 degrees with the vertical direction during the cooking.

25. The automatic cooking device according to claim 23, wherein the image sensor is generally oriented toward the opening of the cooking container and move relative to the cooking container.

26. The automatic cooking device according to claim 23, wherein a transparent part is disposed on the pot body of the cooking container, so that the image sensor acquires an image of the variety of food ingredients in the cooking container with the transparent part.

27. The automatic cooking device according to claim 23, wherein it further comprises a cooking mechanism configured to perform the cooking operation on the variety of food ingredients food ingredient in the cooking container based on the cooking condition parameters.

28. (canceled)

29. The automatic cooking device according to claim 23, wherein the device comprises a temperature sensor for measuring the temperature of the pot body of the cooking container.

30. (canceled)

31. (canceled)

32. The automatic cooking device according to claim 23, wherein it further comprises a range hood to smoke the fumes in the cooking container.

33. The automatic cooking device according to claim 32, wherein the processor is further configured to processing the image acquired by the image sensor to determine smoke interference in the cooking container and the power of the range hood and/or its position relative to the cooking container.
